(19) United States
(12) Patent Application Publication
(10) Pub. No.: US 2025/0294311 A1
(43) Pub. Date: Sep. 18, 2025

(54) DISPLAY METHOD AND INFORMATION PROCESSING APPARATUS

(71) Applicant: FUJIFILM Corporation, Tokyo (JP)

(72) Inventors: Kazuya OKIYAMA, Saitama (JP); Mototada OTSURU, Saitama-shi (JP)

(73) Assignee: FUJIFILM Corporation, Tokyo (JP)

(21) Appl. No.: 19/221,553

(22) Filed: May 29, 2025

Related U.S. Application Data
(63) Continuation of application No. PCT/JP2023/041330, filed on Nov. 16, 2023.

(30) Foreign Application Priority Data
Dec. 23, 2022 (JP) 2022-207654

(51) Int. Cl. H04S 7/00; G06T 13/80; H04N 23/63; H04S 1/00

(52) U.S. Cl. CPC H04S 7/40; G06T 13/80; H04S 1/007; G06T 2200/24; H04N 23/63; H04S 2400/15

(57) ABSTRACT

A display method of the present disclosure includes a first acquisition step of acquiring, based on first sound data having a first bit depth generated based on a sound signal output from a first sound collection device, second sound data having a second bit depth larger than the first bit depth, and an output step of outputting, to a display device, a volume video representing a volume related to the second sound data.

### CROSS-REFERENCE TO RELATED APPLICATIONS

This application is a continuation application of International Application No. PCT/JP2023/041330, filed Nov. 16, 2023, the disclosure of which is incorporated herein by reference in its entirety. Further, this application claims priority from Japanese Patent Application No. 2022-207654, filed on Dec. 23, 2022, the disclosure of which is incorporated herein by reference in its entirety.

### BACKGROUND

### 1. Technical Field

The technique of the present disclosure relates to a display method and an information processing apparatus.

### 2. Description of the Related Art

JP2012-073435A discloses an audio signal conversion device that samples an input analog audio signal of an L channel and an R channel with a sampling frequency of 192 kHz and a quantization bit rate of 24 bits in an A/D conversion device to generate a digital signal. A signal processing device is connected to an output side of the A/D conversion device. This signal processing device performs processing of down-sampling the frequency to ¼ (48 kHz) and processing of converting the down-sampled signal into a floating point format of a quantization bit rate of 32 bits.

JP2002-246913A discloses a data processing device that converts input data from a fixed point format to a floating point format by a conversion unit.

### SUMMARY

An object of one embodiment according to the technique of the present disclosure is to provide a display method and an information processing apparatus capable of easily recognizing whether or not a volume is appropriate.

In order to achieve the above object, a display method of the present disclosure includes a first acquisition step of acquiring, based on first sound data having a first bit depth generated based on a sound signal output from a first sound collection device, second sound data having a second bit depth larger than the first bit depth, and an output step of outputting, to a display device, a volume video representing a volume related to the second sound data.

It is preferable that the display method further includes a second acquisition step of acquiring a subject video representing a video of a subject, in which, in the output step, the volume video and the subject video are output to the display device.

It is preferable that the volume video includes any one of a first video representing a level of the volume or a second video representing a change in the volume smaller than the level represented by the first video.

It is preferable that the volume video includes the second video and the second video is a video representing a temporal change amount of the volume or a video obtained by enlarging a part of the first video.

It is preferable that the volume video includes the first video and the second video, the first sound data includes first modulated sound data obtained by employing a first gain for the sound signal and second modulated sound data obtained by employing a second gain higher than the first gain for the sound signal, the second sound data is sound data generated by combining the first modulated sound data and the second modulated sound data, and the first video represents the level of the volume of the first modulated sound data, and the second video represents the level of the volume of the second modulated sound data.

It is preferable that the volume video includes the first video, the first sound data includes first modulated sound data obtained by employing a first gain for the sound signal and second modulated sound data obtained by employing a second gain higher than the first gain for the sound signal, the second sound data is sound data generated by combining the first modulated sound data and the second modulated sound data, and the first video is a video in which a volume of the second sound data is represented by the second bit depth.

It is preferable that the display method further includes a third acquisition step of acquiring, based on the second sound data, third sound data generated by extracting data of a volume range having a width of a third bit depth smaller than the second bit depth, in which the volume video includes a third video related to the third sound data.

It is preferable that the volume video includes the first video and the third video and the third video is a video related to a volume of the third sound data.

It is preferable that the display method further includes a fourth acquisition step of acquiring a volume of an environmental sound based on a sound signal output from a second sound collection device, in which the volume video includes information related to the volume of the environmental sound.

It is preferable that the volume video includes information related to a ratio between a volume of the second sound data and the volume of the environmental sound.

A display method of the present disclosure includes a first acquisition step of acquiring, based on first sound data having a first bit depth generated based on a sound signal output from a first sound collection device, second sound data having a second bit depth larger than the first bit depth, a third acquisition step of acquiring, based on the second sound data, third sound data generated by extracting data of a volume range having a width of a third bit depth smaller than the second bit depth, and an output step of outputting, to a display device, an auxiliary video related to the third sound data.

It is preferable that the display method further includes a second acquisition step of acquiring a subject video representing a video of a subject in the second sound data, in which, in the output step, the subject video is output to the display device in addition to the auxiliary video.

It is preferable that the auxiliary video is a video related to the volume range.

It is preferable that the auxiliary video is a video related to deterioration information, which is information on a sound deteriorated from the second sound data in the third sound data.

It is preferable that the deterioration information is information related to a sound source of the deteriorated sound.

It is preferable that the display method further includes an extraction step of extracting, from the subject video, subject information corresponding to the sound source, in which the deterioration information is the subject information.

A display method according to the present disclosure includes a first file creation step of creating, based on first sound data having a first bit depth generated based on a sound signal output from a first sound collection device, second sound data having a second bit depth larger than the first bit depth and creating a first file including third sound data generated, based on the second sound data, by extracting data of a volume range having a width of a third bit depth smaller than the second bit depth, a second file creation step of creating a second file including the first sound data, and an output step of outputting, to a display device, a first icon indicating the first file and a second icon indicating the second file in different display aspects.

It is preferable that, in the first file creation step, the volume range of the second sound data is changeable for each predetermined time, and, in the output step, the display aspect of the first icon is changed based on whether or not the volume range is changed on a time axis.

An information processing apparatus according to the present disclosure includes a processor, in which the processor is configured to execute a first acquisition step of acquiring, based on first sound data having a first bit depth generated based on a sound signal output from a first sound collection device, second sound data having a second bit depth larger than the first bit depth, and an output step of outputting, to a display device, a volume video representing a volume related to the second sound data.

An information processing apparatus according to the present disclosure includes a processor, in which the processor is configured to execute a first acquisition step of acquiring, based on first sound data having a first bit depth generated based on a sound signal output from a first sound collection device, second sound data having a second bit depth larger than the first bit depth, a third acquisition step of acquiring, based on the second sound data, third sound data generated by extracting data of a volume range having a width of a third bit depth smaller than the second bit depth, and an output step of outputting, to a display device, an auxiliary video related to the third sound data.

An information processing apparatus according to the present disclosure includes a processor, in which the processor is configured to execute a first file creation step of creating, based on first sound data having a first bit depth generated based on a sound signal output from a first sound collection device, second sound data having a second bit depth larger than the first bit depth and creating a first file including third sound data generated, based on the second sound data, by extracting data of a volume range having a width of a third bit depth smaller than the second bit depth, a second file creation step of creating a second file including the first sound data, and an output step of outputting, to a display device, a first icon indicating the first file and a second icon indicating the second file in different display aspects.

### BRIEF DESCRIPTION OF THE DRAWINGS

Exemplary embodiments according to the technique of the present disclosure will be described in detail based on the following figures, wherein:

FIG. 1 is a diagram showing an example of a configuration of an imaging apparatus according to a first embodiment,

FIG. 2 is a diagram showing an example of a configuration of a sound signal processing circuit,

FIG. 3 is a diagram conceptually showing sound signal processing by the sound signal processing circuit,

FIG. 4 is a diagram showing an example of a functional configuration of a processor,

FIG. 5 is a diagram conceptually showing combination processing and data format conversion processing,

FIG. 6 is a diagram conceptually showing data extraction processing,

FIG. 7 is a diagram showing an example of a volume video,

FIG. 8 is a diagram showing an example of the volume video and a subject video displayed on a display,

FIG. 9 is a flowchart showing an example of an operation of the imaging apparatus,

FIG. 10 is a diagram showing a comparison between a volume display in the related art and a volume display according to the present embodiment,

FIG. 11 is a diagram showing a first modification example of the volume video,

FIG. 12 is a diagram showing a second modification example of the volume video,

FIG. 13 is a diagram showing a third modification example of the volume video,

FIG. 14 is a diagram showing a fourth modification example of the volume video,

FIG. 15 is a diagram showing a fifth modification example of the volume video,

FIG. 16 is a diagram showing a functional configuration of the processor according to a second embodiment,

FIG. 17 is a diagram showing an example of the volume video generated by a volume video generation unit according to the second embodiment,

FIG. 18 is a diagram showing a modification example of the volume video,

FIG. 19 is a flowchart showing an operation of an imaging apparatus according to the second embodiment,

FIG. 20 is a diagram showing an example of the functional configuration of the processor according to a third embodiment,

FIG. 21 is a diagram showing an example of the functional configuration of the processor according to a fourth embodiment,

FIG. 22 is a flowchart showing an operation of an imaging apparatus according to the fourth embodiment,

FIG. 23 is a diagram showing an example of a first icon and a second icon,

FIG. 24 is a diagram for describing a change operation on a volume range to a time axis,

FIG. 25 shows a first icon in a case where the volume range is changed and a first icon in a case where the volume range is not changed, and

FIG. 26 is a diagram showing an example of a video reproduction screen.

### DETAILED DESCRIPTION

An example of an embodiment according to the technique of the present disclosure will be described with reference to accompanying drawings.

First, the terms used in the following description will be described.

In the following description, “AF” is an abbreviation for “auto focus”. “MF” is an abbreviation for “manual focus”. “IC” is an abbreviation for “integrated circuit”. “CPU” is an abbreviation for “central processing unit”. “RAM” is an abbreviation for “random access memory”. “CMOS” is an abbreviation for “complementary metal oxide semiconductor”.

“FPGA” is an abbreviation for “field programmable gate array”. “PLD” is an abbreviation for “programmable logic device”. “ASIC” is an abbreviation for “application specific integrated circuit”. “OVF” is an abbreviation for “optical view finder”. “EVF” is an abbreviation for “electronic view finder”. “ADC” is an abbreviation for “analog to digital converter”. “LPCM” is an abbreviation for “linear pulse code modulation”.

As one embodiment of an imaging apparatus, the technique of the present disclosure will be described by using a lens-interchangeable digital camera as an example. The technique of the present disclosure is not limited to the lens-interchangeable type and can also be employed for a lens-integrated digital camera.

### First Embodiment

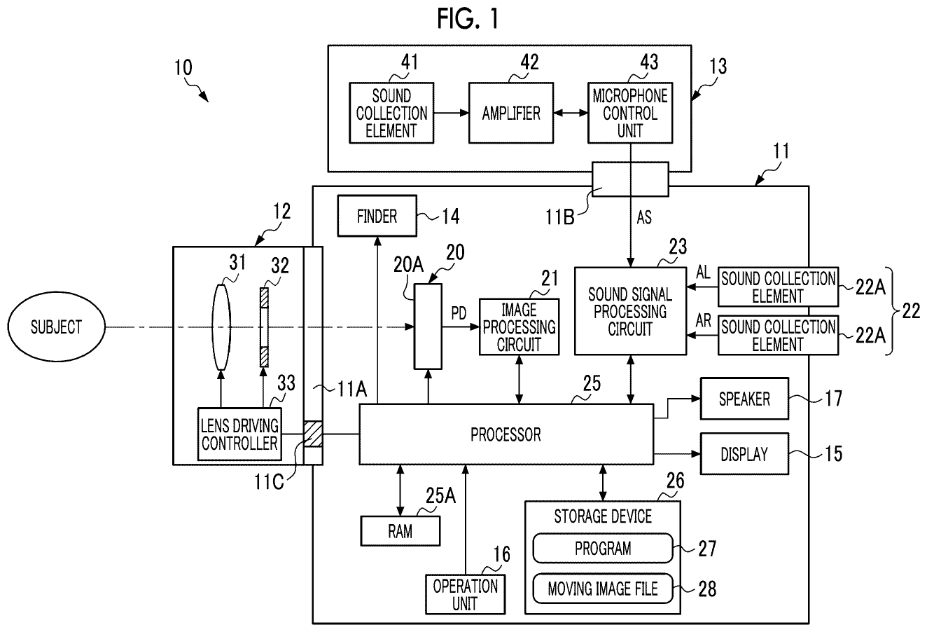

FIG. 1 shows an example of a configuration of an imaging apparatus 10 according to a first embodiment. The imaging apparatus 10 is a lens-interchangeable digital camera. The imaging apparatus 10 is configured of a housing 11 and an imaging lens 12 that is interchangeably mounted on the housing 11 and includes a focus lens 31. The imaging lens 12 is attached to a front surface side of the housing 11 via a mount 11A. The imaging apparatus 10 is an example of “information processing apparatus” according to the technique of the present disclosure.

Further, an external microphone 13 can be attachably and detachably attached to the housing 11. The external microphone 13 is attached to the housing 11 via a connection portion 11B provided on an upper surface of the housing 11. The external microphone 13 is a gun microphone, a zoom microphone, or the like. The connection portion 11B is, for example, a hot shoe.

The housing 11 is provided with an operation unit 16 including a dial, a release button, and the like. Examples of an operation mode of the imaging apparatus 10 include a still image capturing mode, a video capturing mode, and an image display mode. The operation unit 16 is operated by a user in a case where the operation mode is set. Further, the operation unit 16 is operated by the user in a case where execution of still image capturing or video capturing is started.

Further, the housing 11 is provided with a finder 14. For example, the finder 14 is a hybrid finder (registered trademark). The hybrid finder refers to, for example, a finder in which an optical view finder (hereinafter referred to as “OVF”) and an electronic view finder (hereinafter referred to as “EVF”) are selectively used. The user can observe an optical image or a live view image of a subject projected onto the finder 14 via a finder eyepiece portion (not shown).

Further, a display 15 is provided on a rear surface side of the housing 11. The display 15 displays a subject video obtained by imaging, various menu screens, and the like. The user can also observe the live view image projected onto the display 15, instead of the finder 14. Note that the display 15 is an example of a “display device” according to the technique of the present disclosure.

Further, the housing 11 is provided with a speaker 17. The speaker 17 outputs a sound based on sound data included in a moving image file 28 described below.

The housing 11 is electrically connected to the imaging lens 12 via an electrical contact 11C provided on the mount 11A.

The imaging lens 12 includes a focus lens 31, a stop 32, and a lens driving controller 33. The lens driving controller 33 is electrically connected to a processor 25 accommodated in the housing 11, via the electrical contact 11C.

The lens driving controller 33 drives the focus lens 31 and the stop 32, based on control signals transmitted from the processor 25. The lens driving controller 33 performs drive control of the focus lens 31, based on the control signal for the focusing control that is transmitted from the processor 25, in order to adjust a position of the focus lens 31.

The stop 32 has an opening with a variable opening diameter. The lens driving controller 33 performs drive control of the stop 32, based on the control signal for stop adjustment that is transmitted from the processor 25, in order to adjust an amount of light incident on an imaging sensor 20.

Further, the imaging sensor 20, an image processing circuit 21, a built-in microphone 22, a sound signal processing circuit 23, the processor 25, and a storage device 26 are provided inside the housing 11. The processor 25 controls operations of the imaging sensor 20, the image processing circuit 21, the built-in microphone 22, the sound signal processing circuit 23, the storage device 26, the display 15, and the speaker 17.

The processor 25 is configured of, for example, a CPU. The processor 25 is connected to a RAM 25A, which is a memory for primary storage. The storage device 26 is configured of, for example, a non-volatile memory such as a flash memory. The processor 25 executes various types of processing based on a program 27 stored in the storage device 26. The processor 25 may be configured of an assembly of a plurality of IC chips. Further, for example, the storage device 26 stores the moving image file 28 generated as a result of the imaging apparatus 10 executing an imaging operation.

The imaging sensor 20 is, for example, a CMOS-type image sensor. Light (subject image) that has passed through the imaging lens 12 is incident on a light-receiving surface 20A of the imaging sensor 20. A plurality of pixels that generate imaging signals through photoelectric conversion are formed on the light-receiving surface 20A. The imaging sensor 20 performs the photoelectric conversion on light incident on each pixel to generate and output data representing the subject video. Hereinafter, the data representing the subject video is simply referred to as a subject video PD.

The image processing circuit 21 performs, on the subject video PD output from the imaging sensor 20, image processing including white balance correction, gamma correction processing, and the like.

The built-in microphone 22 is a stereo microphone including a pair of sound collection elements 22A and 22B. The sound collection elements 22A and 22B are sound sensors for a left side channel (hereinafter referred to as L channel) and a right side channel (hereinafter referred to as R channel). The sound collection elements 22A and 22B are sound sensors of an electrostatic type, a piezoelectric type, an electrodynamic type, or the like, and output collected sounds as sound signals AL and AR. The sound signal processing circuit 23 performs sound signal processing including gain processing, A/D conversion processing, and the like on the sound signals AL and AR output from the sound collection elements 22A and 22B. The built-in microphone 22 is an example of “second sound collection device” according to the technique of the present disclosure.

The external microphone 13 includes a sound collection element 41, an amplifier 42, and a microphone control unit 43. In the present embodiment, the external microphone 13 is a mono microphone having one sound collection element 41. The sound collection element 41 is a sound sensor of an electrostatic type, a piezoelectric type, an electrodynamic type, or the like, and outputs a collected sound as the sound signal. The amplifier 42 performs the gain processing on the sound signal output from the sound collection element 41. The microphone control unit 43 controls a gain amount of the gain processing by the amplifier 42. The external microphone 13 is an example of “first sound collection device” according to the technique of the present disclosure.

Further, the microphone control unit 43 supplies the sound signal subjected to the gain processing by the amplifier 42 to the sound signal processing circuit 23 in the housing 11 via the connection portion 11B. A mono and analog sound signal AS is supplied from the external microphone 13 to the sound signal processing circuit 23. The processor 25 controls the operation of the microphone control unit 43.

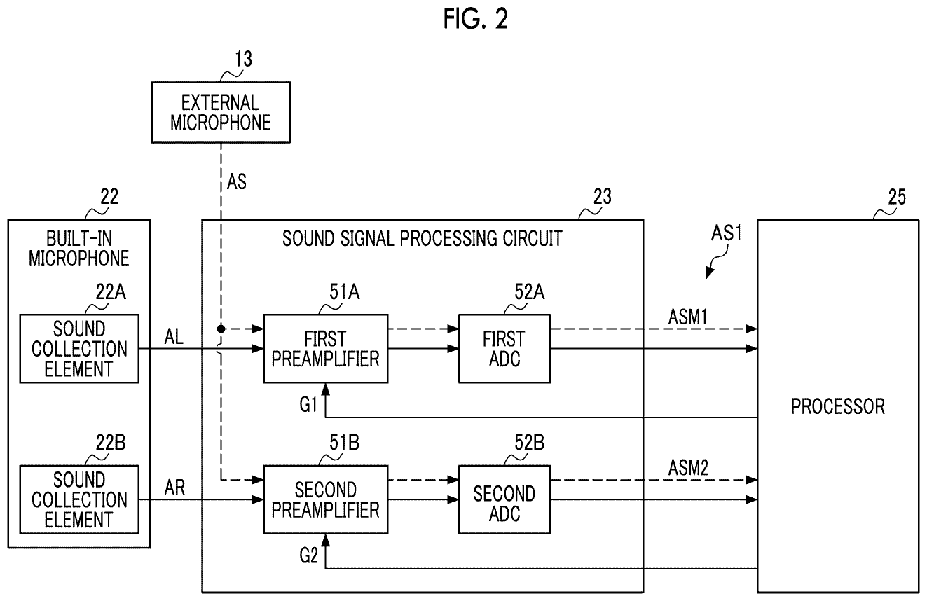

FIG. 2 shows an example of a configuration of the sound signal processing circuit 23. The sound signal processing circuit 23 includes a first preamplifier 51A, a first ADC 52A, a second preamplifier 51B, and a second ADC 52B.

The first preamplifier 51A and the first ADC 52A are processing units for L-channel that perform the gain processing and the A/D conversion processing on the sound signal AL output from the sound collection element 22A included in the built-in microphone 22. The second preamplifier 51B and the second ADC 52B are processing units for R-channel that perform the gain processing and the A/D conversion processing on the sound signal AR output from the sound collection element 22B included in the built-in microphone 22.

In the first preamplifier 51A, the processor 25 controls a gain amount G1. In the second preamplifier 51B, the processor 25 controls a gain amount G2. In a case where the gain processing is performed on the sound signals AL and AR output from the built-in microphone 22, the processor 25 sets the gain amount G1 and the gain amount G2 to the same value. The first ADC 52A and the second ADC 52B perform sampling with, for example, a quantization bit rate of 24 bits to convert an analog sound signal into a digital signal of a 24-bit LPCM format. The above is an example of a pulse code modulation format.

In a case where the external microphone 13 is connected to the connection portion 11B, the sound signal AS output from the external microphone 13 is input to the sound signal processing circuit 23. In this case, the operation of the built-in microphone 22 is invalidated, and the sound signal is not input from the built-in microphone 22 to the sound signal processing circuit 23.

The sound signal AS output from the external microphone 13 is input to the first preamplifier 51A and the second preamplifier 51B. The first preamplifier 51A performs the gain processing on the sound signal AS with the gain amount G1. The second preamplifier 51B performs the gain processing on the sound signal AS with the gain amount G2. In a case where the gain processing is performed on the sound signal AS output from the external microphone 13, the processor 25 sets the gain amount G1 and the gain amount G2 to different values. Hereinafter, the gain processing performed by the first preamplifier 51A is referred to as first gain processing, and the gain processing performed by the second preamplifier 51B is referred to as second gain processing.

The first ADC 52A converts the sound signal AS subjected to the first gain processing by the first preamplifier 51A into the digital signal. The second ADC 52B converts the sound signal AS subjected to the second gain processing by the second preamplifier 51B into the digital signal. Hereinafter, the sound signal AS digitized by the first ADC 52A is referred to as first modulated sound data ASM1, and the sound signal AS digitized by the second ADC 52B is referred to as second modulated sound data ASM2. Further, the sound data generated based on the sound signal AS output from the external microphone 13 is referred to as first sound data AS1. The first sound data AS1 includes first modulated sound data ASM1 and second modulated sound data ASM2. The first sound data AS1 is output from the sound signal processing circuit 23 to the processor 25.

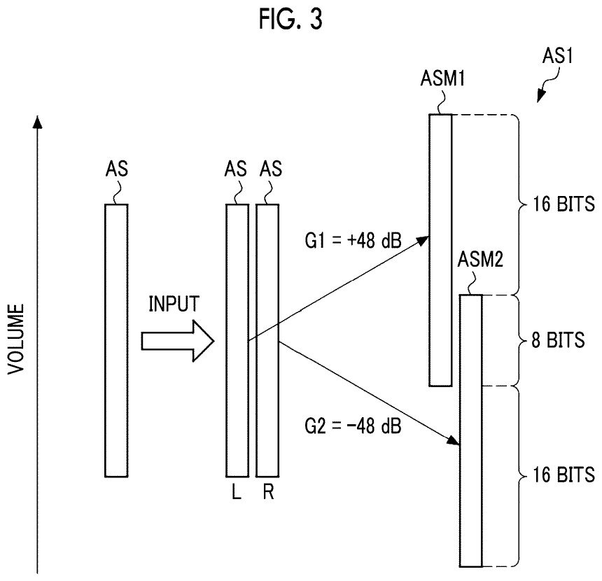

FIG. 3 conceptually shows the sound signal processing by the sound signal processing circuit 23. The sound signal AS output from the external microphone 13 is input to the processing unit for L-channel and the processing unit for R-channel. The sound signal AS input to the processing unit for L-channel is subjected to the first gain processing with the gain amount G1, then is converted into the digital signal, and thus, is output from the sound signal processing circuit 23 as the first modulated sound data ASM1. The sound signal AS input to the processing unit for R-channel is subjected to the second gain processing with the gain amount G2, then is converted into the digital signal, and thus, is output from the sound signal processing circuit 23 as the second modulated sound data ASM2. In the present embodiment, the bit depth (hereinafter referred to as a first bit depth) of the first sound data AS1 is 24 bits.

For example, the gain amount G1 is assumed to be +48 dB, and the gain amount G2 is assumed to be −48 dB. Since 48 dB corresponds to a volume width of 8 bits, there is a deviation of 16 bits between the first modulated sound data ASM1 of high gain and the second modulated sound data ASM2 of low gain, as shown in FIG. 3. In other words, the first modulated sound data ASM1 overlaps with the second modulated sound data ASM2 by 8 bits.

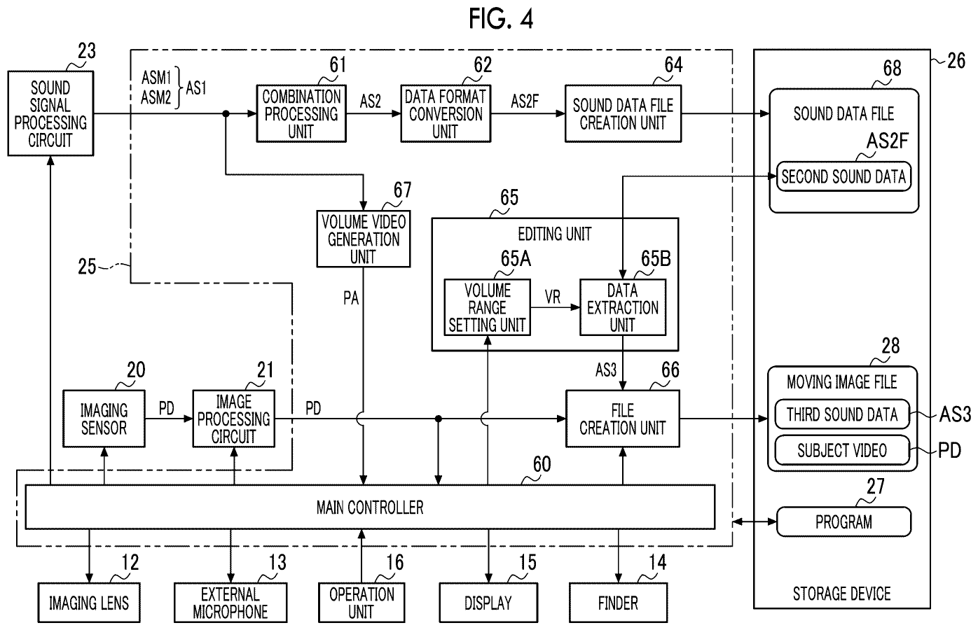

FIG. 4 shows an example of a functional configuration of the processor 25. The processor 25 executes the processing according to the program 27, which is stored in the storage device 26, to implement various functional units. Various functional units shown in FIG. 4 are implemented in the video capturing mode. As shown in FIG. 4, for example, a main controller 60, a combination processing unit 61, a data format conversion unit 62, a sound data file creation unit 64, an editing unit 65, a file creation unit 66, and a volume video generation unit 67 are implemented in the processor 25. The editing unit 65 includes a volume range setting unit 65A and a data extraction unit 65B.

The main controller 60 integrally controls each unit of the imaging apparatus 10. The main controller 60 controls the operation of the imaging apparatus 10 based on an instruction signal input from the operation unit 16. The main controller 60 controls the imaging sensor 20 to cause the imaging sensor 20 to perform the imaging operation. The imaging sensor 20 outputs the subject video PD, which is generated by performing the imaging via the imaging lens 12. In the video capturing mode, the imaging sensor 20 outputs the subject video PD for each frame cycle. The subject video PD output from the imaging sensor 20 is subjected to the image processing by the image processing circuit 21 and then input to the processor 25.

Further, in the video capturing mode, in a case where the external microphone 13 is connected to the connection portion 11B, the main controller 60 controls the external microphone 13 to perform a sound collection operation. The external microphone 13 outputs the sound signal AS to the sound signal processing circuit 23 via the connection portion 11B while the imaging sensor 20 performs the imaging operation. The sound signal processing circuit 23 performs the above sound signal processing to generate and output first sound data AS1, which includes the first modulated sound data ASM1 and the second modulated sound data ASM2, having the first bit depth. That is, the first sound data AS1 corresponds to the subject video PD obtained by the imaging sensor 20 imaging the subject.

The combination processing unit 61 acquires the first sound data AS1 output from the sound signal processing circuit 23 and combines the first modulated sound data ASM1 and the second modulated sound data ASM2 included in the first sound data AS1 to create second sound data AS2. The second sound data AS2 is digital data of the LPCM format.

The data format conversion unit 62 converts a data format of the second sound data AS2 into a floating point format. Hereinafter, the second sound data AS2 converted into the floating point format is referred to as second sound data AS2F. The second sound data AS2F has a second bit depth, which is larger than the first bit depth. In the present embodiment, the second bit depth is 32 bits.

The sound data file creation unit 64 creates a sound data file 68 including the second sound data AS2F created by the data format conversion unit 62. The sound data file creation unit 64 records the created sound data file 68 in the storage device 26.

The editing unit 65 refers to the sound data file 68 recorded in the storage device 26 to create third sound data AS3 having a third bit depth, which is smaller than the second bit depth, based on the second sound data AS2F. For example, the third bit depth is 24 bits.

Specifically, the volume range setting unit 65A sets a volume range VR having a width of the third bit depth for a dynamic range of the second sound data AS2F. In the present embodiment, the volume range setting unit 65A sets the volume range VR based on designation information input from the main controller 60. The data extraction unit 65B extracts data of the volume range VR set by the volume range setting unit 65A to create the third sound data AS3, based on the second sound data AS2F. The third sound data AS3 is digital data of the LPCM format.

The file creation unit 66 creates the moving image file 28 including the subject video PD, which is output from the image processing circuit 21, and the third sound data AS3, which is output from the data extraction unit 65B, and stores the moving image file 28 in the storage device 26.

The volume video generation unit 67 generates a volume video PA representing a volume related to the second sound data AS2F. In the present embodiment, the volume video generation unit 67 generates the volume video PA, based on the first modulated sound data ASM1 and the second modulated sound data ASM2 included in the first sound data AS1.

The main controller 60 outputs, to the display 15, the volume video PA generated by the volume video generation unit 67 and the subject video PD generated by the image processing circuit 21. The display 15 displays the volume video PA and the subject video PD, which are input from the main controller 60.

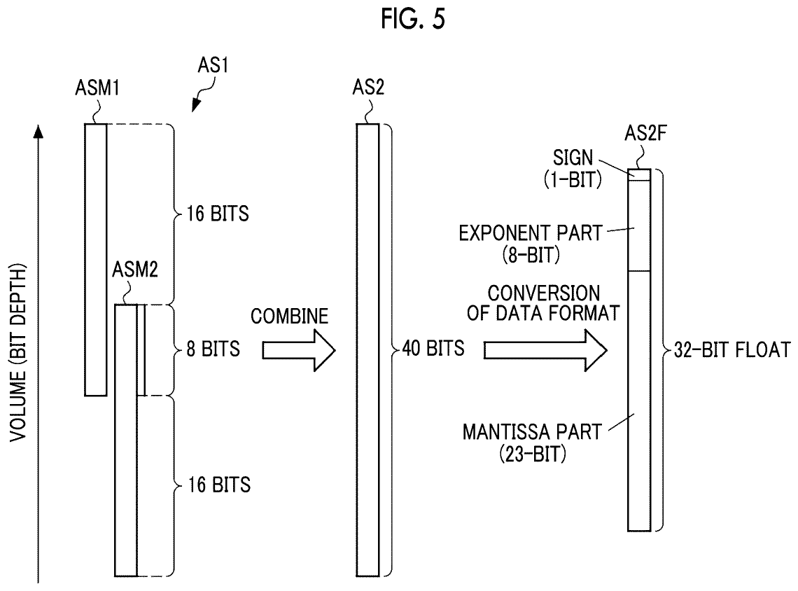

FIG. 5 conceptually shows combination processing by the combination processing unit 61 and data format conversion processing by the data format conversion unit 62. The combination processing unit 61 performs the mixing processing on the overlap portion of 8 bits between the first modulated sound data ASM1 and the second modulated sound data ASM2 to combine the first modulated sound data ASM1 and the second modulated sound data ASM2. The bit depth of the second sound data AS2, which is generated by the combination processing, is 40 bits. In this manner, with the combination of the first modulated sound data ASM1 and the second modulated sound data ASM2 having different gain amounts, it is possible to obtain the second sound data AS2 with an expanded volume dynamic range.

The data format conversion unit 62 converts the second sound data AS2 of a 40-bit fixed point format into the second sound data AS2F of a 32-bit floating point format (so-called 32-bit float). The 32-bit float is configured of a 1-bit sign, an 8-bit exponent part, and a 23-bit mantissa part. A known method can be used for the conversion from the fixed point format to the floating point format. In the floating point format, a wide range of numerical values can be expressed.

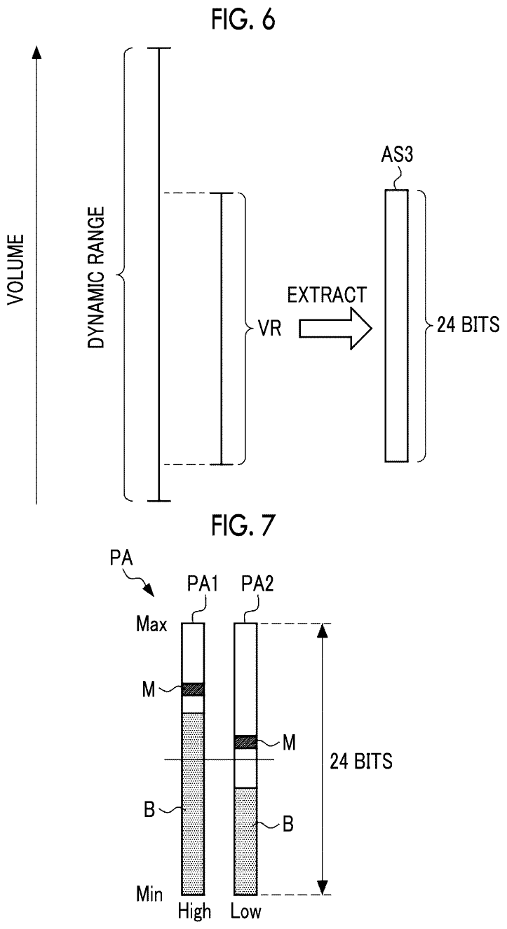

FIG. 6 conceptually shows data extraction processing by the data extraction unit 65B. The data extraction unit 65B extracts the data of the volume range VR set by the volume range setting unit 65A to create third sound data AS3 of a 24-bit fixed point format, based on the second sound data AS2F. Specifically, the data extraction unit 65B selects values of the sign and the exponent part of the 32-bit float according to the volume range VR to create the third sound data AS3 of 24 bits represented by the mantissa part.

In general, since the sound data included in a moving image file is the digital data of the 24-bit LPCM format, the third sound data AS3 of 24 bits is created in the present embodiment.

For example, the volume range VR is set according to the operation of the user using the operation unit 16. In this case, the main controller 60 supplies, to the volume range setting unit 65A, an operation signal of the user input from the operation unit 16. The volume range setting unit 65A sets the volume range VR based on the operation signal supplied from the main controller 60. The user can set the volume range VR to a desired position within the dynamic range of the second sound data AS2F by using the operation unit 16. Further, the user can operate the operation unit 16 to change the set position of the volume range VR for the second sound data AS2F for each predetermined time.

FIG. 7 shows an example of the volume video PA. In the present embodiment, the volume video PA includes a first video PA1 and a second video PA2. The volume video generation unit 67 generates the first video PA1 based on the first modulated sound data ASM1, and generates the second video PA2 based on the second modulated sound data ASM2. In the present embodiment, the first video PA1 and the second video PA2 are each an indicator representing a level of the volume by a volume bar B.

The second video PA2 is generated based on the second modulated sound data ASM2 for which a lower gain than the first modulated sound data ASM1 is employed. Thus, the second video PA2 represents a change in a volume smaller than the level of the volume represented by the first video PA1.

Further, the first video PA1 and the second video PA2 each have marks M indicating maximum values of the levels within a predetermined period in the past. The volume video generation unit 67 may change a color or the like of the mark M according to whether or not the maximum value is within an appropriate range.

Further, a scale indicating the level of the volume may be displayed in a unit such as decibels (dB) in the first video PA1 and the second video PA2. The scale may be at an equal spacing or may be at a non-equal spacing.

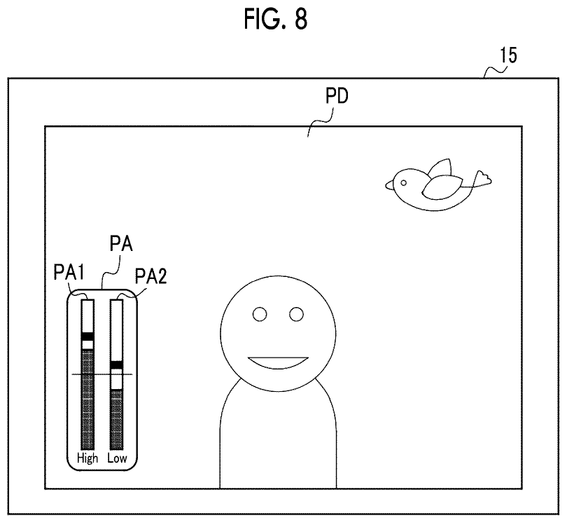

FIG. 8 shows an example of the volume video PA and the subject video PD, which are displayed on the display 15. As shown in FIG. 8, for example, the volume video PA is displayed so as to be superimposed on a part of the subject video PD. With the volume video PA displayed on the display 15, the user can easily recognize whether or not the volume of the second sound data AS2F is appropriate. With the recognition of the volume of the second sound data AS2F, the user can appropriately set the volume range VR in a case where the third sound data AS3 is created.

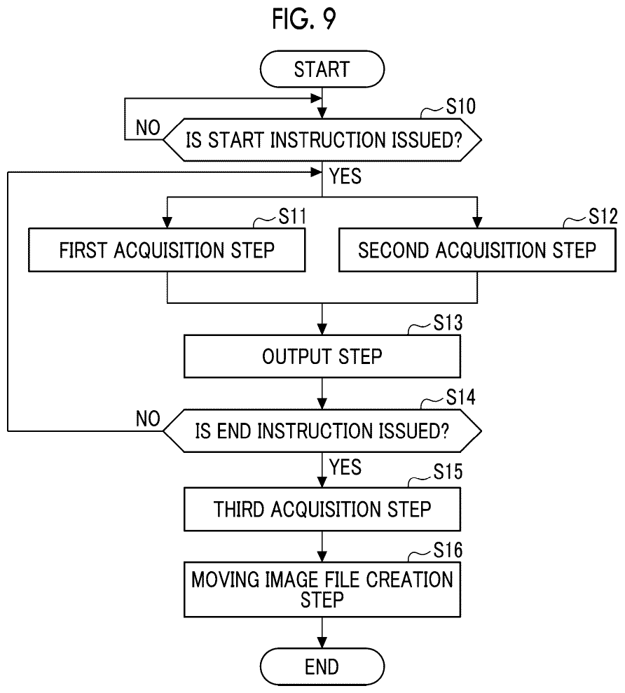

FIG. 9 is a flowchart showing an example of the operation of the imaging apparatus 10. FIG. 9 shows an operation in a case where the video capturing mode is selected as the operation mode and the external microphone 13 is connected to the connection portion 11B.

First, the main controller 60 determines whether or not the user issues a start instruction for the video capturing (step S10). In a case where the start instruction is determined to be issued (YES in step S10), a first acquisition step (step S11) and a second acquisition step (step S12) are executed in parallel.

In the first acquisition step, the second sound data AS2F having the second bit depth, which is larger than the first bit depth, is acquired based on the first sound data AS1 having the first bit depth generated based on the sound signal AS output from the external microphone 13. In the present embodiment, the first sound data AS1 includes the first modulated sound data ASM1 and the second modulated sound data ASM2. The sound signal AS is subjected to the gain processing with different gain amounts in the sound signal processing circuit 23 and then the A/D conversion is performed to generate the first modulated sound data ASM1 and the second modulated sound data ASM2. The data format conversion unit 62 converts the data format of the second sound data AS2, which is generated by combining the first modulated sound data ASM1 and the second modulated sound data ASM2 in the combination processing unit 61, to generate the second sound data AS2F. Further, in the first acquisition step, the sound data file 68 including the second sound data AS2F is created by the sound data file creation unit 64, and is recorded in the storage device 26.

In the second acquisition step, the subject video PD representing a video of the subject generated by the imaging sensor 20 imaging the subject is acquired. In the present embodiment, the image processing circuit 21 performs the image processing on the subject video PD.

After the first acquisition step and the second acquisition step, an output step is executed (step S13). In the output step, the volume video generation unit 67 generates the volume video PA representing the volume related to the second sound data AS2F. In the present embodiment, the volume video PA including the first video PA1 and the second video PA2 is generated based on the first modulated sound data ASM1 and the second modulated sound data ASM2. Further, in the output step, the main controller 60 outputs the volume video PA and the subject video PD to the display 15 to display the volume video PA and the subject video PD on the display 15.

After the output step, the main controller 60 determines whether or not the user issues an end instruction for the video capturing (step S14). In a case where the end instruction is determined to be not issued (NO in step S14), the processing returns to steps S11 and S12. Steps S11 to S12 are repeatedly executed until the end instruction is determined to be issued in step S14.

In a case where the end instruction is determined to be issued (YES in step S14), a third acquisition step is executed (step S15). In the third acquisition step, the sound data file 68 recorded in the storage device 26 is read out, and the third sound data AS3 generated by extracting the data of the volume range VR having the third bit depth, which is smaller than the second bit depth, is acquired based on the second sound data AS2F. For example, the volume range VR is set based on the operation of the user performed by using the operation unit 16.

After the third acquisition step, a moving image file creation step is executed (step S16). In the moving image file creation step, the moving image file 28 including the subject video PD, which is generated for a plurality of frames, and the third sound data AS3 is created and recorded in the storage device 26. The operation of the imaging apparatus 10 is ended as described above.

In the operation of the imaging apparatus 10 described above, with the volume video PA displayed on the display 15, the user can check whether or not the volume level of the sound generated by the subject is appropriate.

Next, effects of the imaging apparatus 10 according to the present embodiment will be described. In a general format of the moving image file, for example, the bit depth of sound data incorporated in the moving image file is required to be 24 bits or less. In the present embodiment, the second sound data AS2F with the expanded bit depth of 32 bits is generated and recorded at the time of the video capturing, but the second sound data AS2F of 32 bits is down-converted to the third sound data AS3 of 24 bits due to the relation of the format. Further, in the present embodiment, the volume range VR is set in order to extract the sound generated by a desired subject from the second sound data AS2F in the case of the down-conversion.

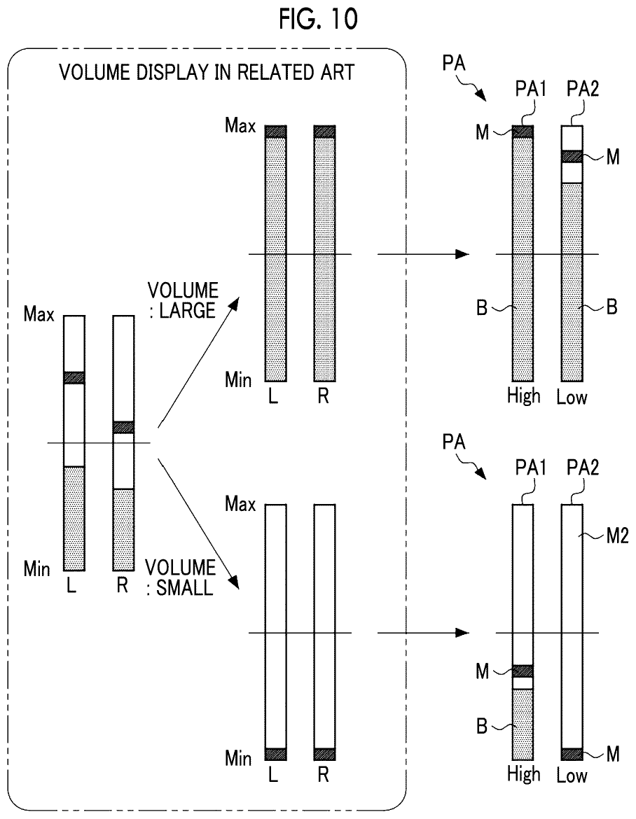

FIG. 10 shows a comparison between a volume display in the related art and a volume display according to the present embodiment. In a sound level display in the related art, for example, the sound signals AL and AR collected by the built-in microphone 22 are each converted into the sound data of 24 bits to display the level of the volume. In a case where the volume of the subject is large and the level of the volume of the sound data of 24 bits reaches a maximum value (Max), in the volume display in the related art, it is unclear whether or not the level of the volume of the second sound data AS2F of 32 bits reaches the maximum value. Conversely, in a case where the volume of the subject is small and the level of the volume of the sound data of 24 bits is a minimum value (Min), in the volume display in the related art, it is unclear whether or not the level of the volume of the second sound data AS2F of 32 bits is the minimum value. In this manner, in the volume display in the related art, it is unclear whether or not a defect, such as sound cracking due to a loud sound or missing of a small sound pickup, occurs in the second sound data AS2F recorded at the time of the video capturing. In a case where the defect occurs in the second sound data AS2F, the sound generated by the desired subject cannot be extracted regardless of the setting of the volume range VR, and thus the third sound data AS3 with high quality may not be obtained.

On the contrary, in the present embodiment, since the volume video PA representing the volume of the second sound data AS2F of 32 bits is displayed at the time of the video capturing, the user can recognize whether or not the defect, such as sound cracking due to a loud sound or missing of a small sound pickup, occurs in the second sound data AS2F. For example, as shown in FIG. 10, even in a case where the level of the volume reaches the maximum value in the volume display in the related art, with the volume video PA of the present embodiment, it may be possible to confirm that no “sound cracking” occurs. Conversely, even in a case where the level of the volume is the minimum value in the volume display in the related art, with the volume video PA of the present embodiment, it may be possible to confirm that no “missing of sound pickup” occurs. In this manner, according to the present embodiment, with reference to the volume video PA displayed in a case where the second sound data AS2F is recorded at the time of the video capturing, the user can recognize in advance whether or not the third sound data AS3 with high quality is obtained by the down-conversion after the video capturing is ended. Therefore, the user can detect in advance presence or absence of a recording failure of the second sound data AS2F at the time of the video capturing.

### Modification Example

Hereinafter, various modification examples of the first embodiment will be described. In the above embodiment, the second sound data AS2F of 32 bits is down-converted to generate the third sound data AS3, but the second sound data AS2 of 40 bits may be down-converted to generate the third sound data AS3. In this case, the “second sound data having second bit depth” according to the technique of the present disclosure is the second sound data AS2, and the second bit depth is 40 bits.

Further, various modifications for the volume video PA, which is generated by the volume video generation unit 67, can be made as described below.

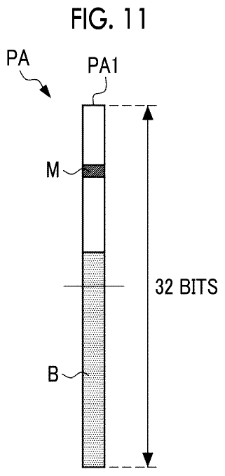

In the above embodiment, the volume video PA includes the first video PA1 and the second video PA2, but may include only the first video PA1. For example, the volume video PA may include only the first video PA1, which represents the volume of the second sound data AS2F by the second bit depth, as shown in FIG. 11. Similarly to the above embodiment, the first video PA1 is an indicator representing the level of the volume by the volume bar B. Further, the mark M indicates the maximum value of the level within the predetermined period in the past.

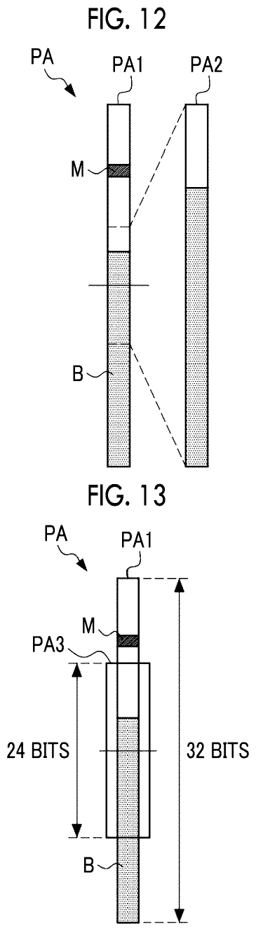

Further, the volume video PA may include the second video PA2 obtained by enlarging a part of the first video PA1, in addition to the first video PA1, which represents the volume of the second sound data AS2F by the second bit depth, as shown in FIG. 12. Further, the second video PA2 may represent a temporal change amount of the volume of the second sound data AS2F. For example, the second video PA2 may represent a difference value of the level of the volume between a current frame and a previous frame. Further, the second video PA2 may represent an absolute value of the difference value.

Further, the volume video PA may include a third video PA3 related to the third sound data AS3, as shown in FIG. 13. The first video PA1 shown in FIG. 13 represents the volume of the second sound data AS2F by the second bit depth. The third video PA3 indicates the volume range VR having the width of the third bit depth for generating the third sound data AS3. Further, the volume video generation unit 67 may decide a position of the third video PA3 with respect to the first video PA1 according to the level of the volume of the second sound data AS2F within the predetermined period in the past. For example, the third video PA3 may be disposed such that a median value or an average value of the level of the volume of the second sound data AS2F within the predetermined period in the past is a center. In this manner, with the display of the third video PA3, the user can easily perform the setting operation of the volume range VR at the time of the editing after the video capturing.

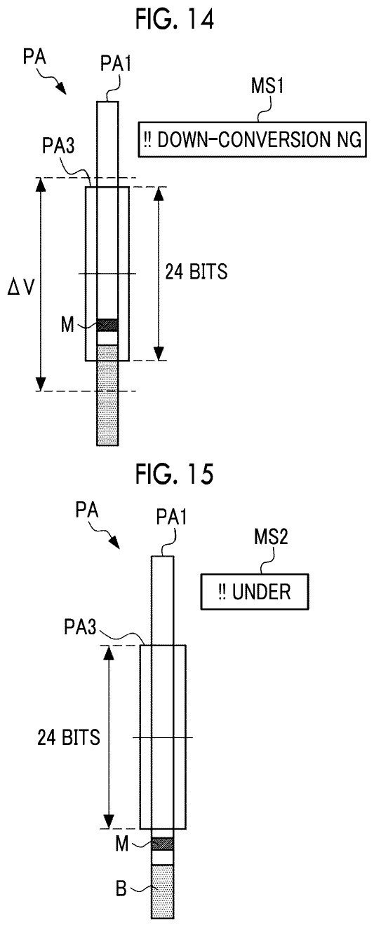

Further, the volume video generation unit 67 may calculate a difference value ΔV between the maximum value and the minimum value of the level of the volume of the second sound data AS2F in a period from the start of the video capturing to the generation of the volume video PA, as shown in FIG. 14. In a case where the calculated difference value ΔV exceeds the width of the volume range VR, the volume video generation unit 67 may display a warning message MS1 in the volume video PA. In a case where the third sound data AS3 is generated by the down-conversion, the warning message MS1 indicates that the sound cracking, the missing of sound pickup, and the like occur.

Further, in a case where the level of volume of the second sound data AS2F falls below a lower limit of the volume range VR, the volume video generation unit 67 may display a warning message MS2 in the volume video PA, as shown in FIG. 15. Similarly, in a case where the level of the volume of the second sound data AS2F exceeds an upper limit of the volume range VR, the volume video generation unit 67 may display a warning message in the volume video PA.

### Second Embodiment

Next, an imaging apparatus according to a second embodiment will be described. In the imaging apparatus according to the present embodiment, only the functional configuration of the processor 25 is different from that of the above embodiment.

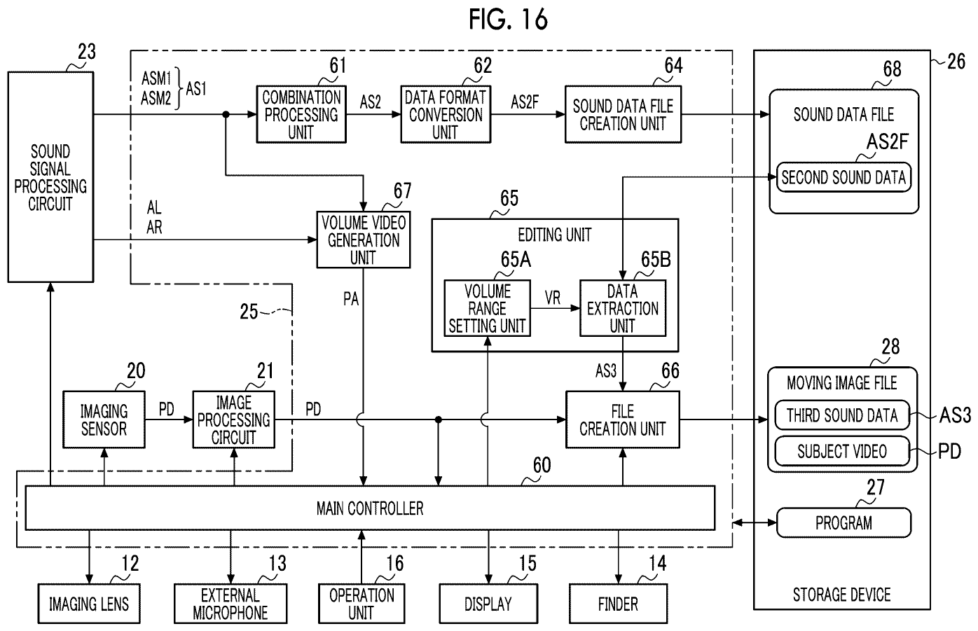

FIG. 16 shows an example of the functional configuration of the processor 25 according to the second embodiment. In the present embodiment, the volume video generation unit 67 further acquires information related to the volume of an environmental sound, based on the sound signals AL and AR output from the built-in microphone 22. Since the external microphone 13 has directivity, such as a gun microphone, the external microphone 13 mainly collects a sound (hereinafter referred to as desired sound) of a main subject desired by the user. On the contrary, since the built-in microphone 22 is an omnidirectional microphone that does not have directivity, the built-in microphone 22 widely collects sounds including the environmental sound other than the sound of the main subject. The volume video generation unit 67 may acquire the volume of the environmental sound based on a difference between the sound collected by the external microphone 13 and the sound collected by the built-in microphone 22.

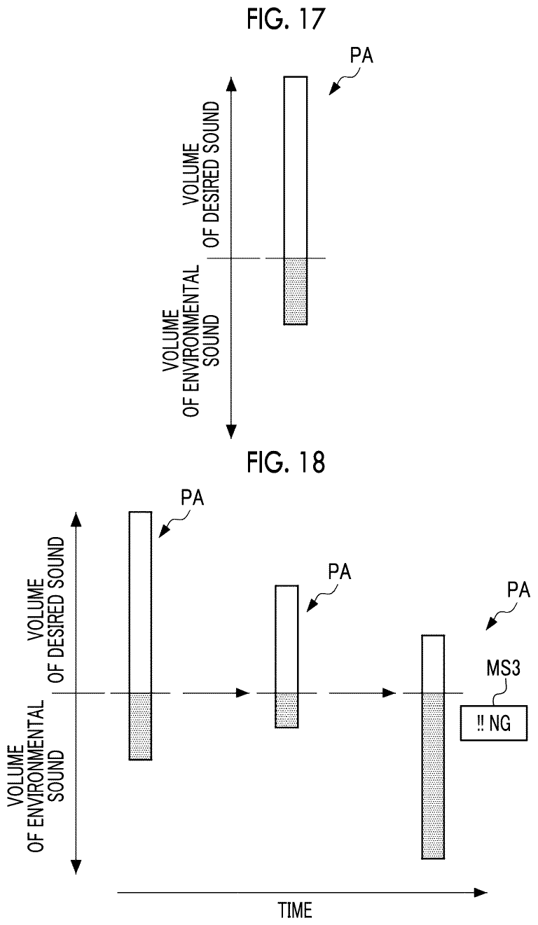

FIG. 17 shows an example of the volume video PA generated by the volume video generation unit 67 according to the second embodiment. In the present embodiment, the volume video generation unit 67 generates the volume video PA including the information related to the volume of the environmental sound. For example, the volume video PA includes information related to a ratio between the volume of the second sound data AS2F and the volume of the environmental sound. The volume video PA shown in FIG. 17 represents a ratio between the level of the volume of the sound of the second sound data AS2F (that is, desired sound) and the level of the volume of the environmental sound in a comparable manner. With the volume video PA of the present embodiment, the user can recognize, at the time of the video capturing, whether or not the desired sound is canceled by the environmental sound.

In a case where the volume of the desired sound is smaller than the volume of the environmental sound, there is a possibility that the desired sound is canceled and disappears due to the environmental sound. Thus, in a case where the volume of the desired sound is smaller than the volume of the environmental sound, the volume video generation unit 67 may display a warning message MS3 in the volume video PA, as shown in FIG. 18.

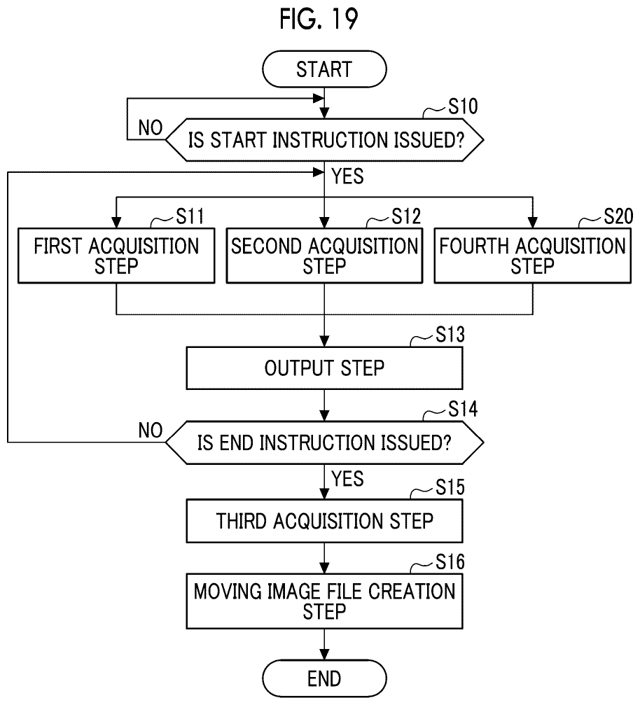

FIG. 19 is a flowchart showing an operation of the imaging apparatus according to the second embodiment. In the present embodiment, in a case where the main controller 60 determines that the start instruction is issued, a fourth acquisition step (step S20) is executed in addition to the first acquisition step (step S11) and the second acquisition step (step S12). In the fourth acquisition step, the information related to the volume of the environmental sound is acquired based on the sound signals AL and AR output from the built-in microphone 22. Further, in the output step (step S13), the volume video generation unit 67 generates the volume video PA including the information related to the volume of the environmental sound. Other operations are the same as those in the first embodiment.

The same modification as the first embodiment can also be employed for the present embodiment.

### Third Embodiment

Next, an imaging apparatus according to a third embodiment will be described. In the imaging apparatus according to the present embodiment, only the functional configuration of the processor 25 is different from that of the above embodiment.

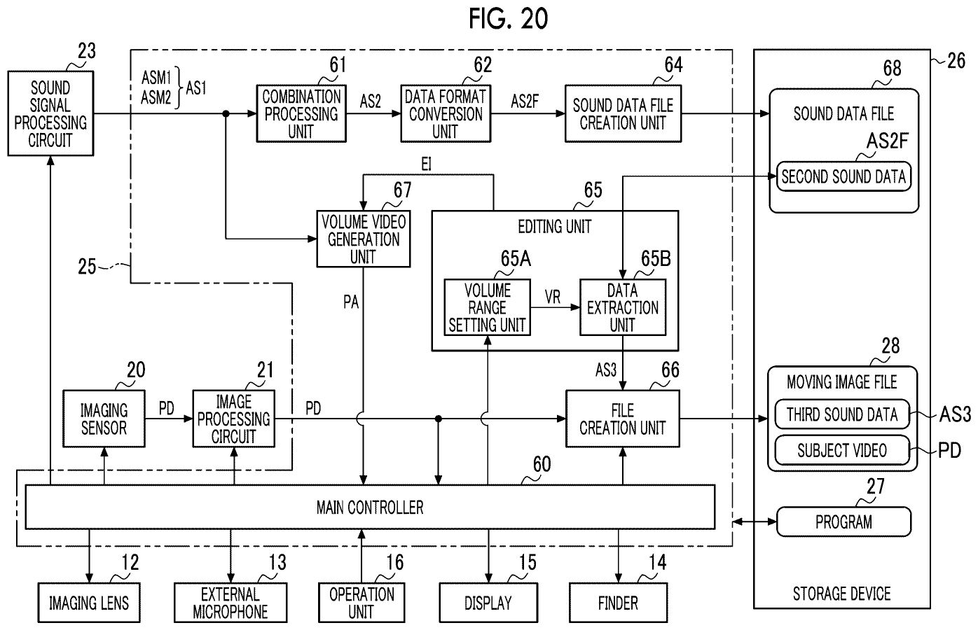

FIG. 20 shows an example of a functional configuration of the processor 25 according to the third embodiment. In the present embodiment, the volume video generation unit 67 creates an auxiliary video based on information EI obtained from the editing unit 65, and generates the volume video PA including the auxiliary video. For example, the auxiliary video relates to the volume range VR having the width of the third bit depth for generating the third sound data AS3. The auxiliary video may be the same video as the third video PA3 shown in FIG. 13.

The auxiliary video may relate to deterioration information, which is information on a sound deteriorated from the second sound data AS2F in a case where the third sound data AS3 is generated. The deterioration means that at least a part of a sound of a sound source, which is included in the second sound data AS2F, is not included in the volume range of the third sound data AS3. The deterioration information is sound information that is lost, from the second sound data AS2F, in a case where the third sound data AS3 having a smaller amount of information than the second sound data AS2F is created. That is, the deterioration information is information included in a range other than the volume range VR of the second sound data AS2F.

The deterioration information may relate to the sound source of the deteriorated sound. The sound source of the deteriorated sound is, for example, a type of the sound source of the sound deteriorated from the second sound data AS2F. For example, in a case where a person and a bird are present in the subject video PD and a sound generated by the bird is lost, the “bird” is specified as the sound source of the deteriorated sound, as shown in FIG. 8. In this manner, the volume video generation unit 67 may execute an extraction step of extracting, from the subject video PD, subject information corresponding to the sound source. In this case, the deterioration information is the subject information. The subject information is information such as a type of the subject corresponding to the sound source of the deteriorated sound.

The same modification as the first embodiment can also be employed for the present embodiment.

### Fourth Embodiment

Next, an imaging apparatus according to a fourth embodiment will be described. In the imaging apparatus according to the present embodiment, only the functional configuration of the processor 25 is different from that of the above embodiment.

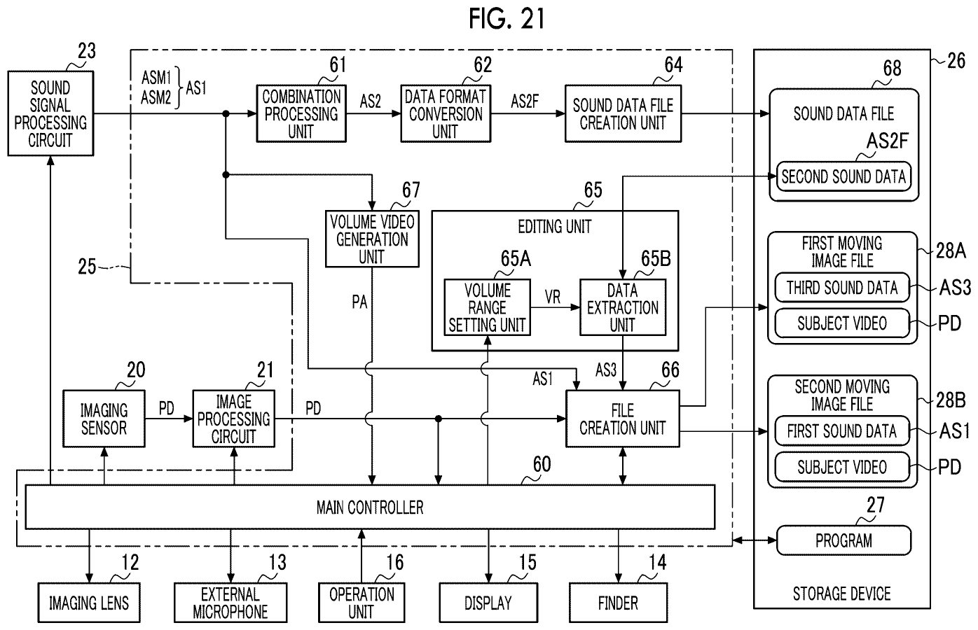

FIG. 21 shows an example of a functional configuration of the processor 25 according to the fourth embodiment. In the present embodiment, the file creation unit 66 can create a second moving image file 28B including the subject video PD and the first sound data AS1, in addition to a first moving image file 28A including the subject video PD and the third sound data AS3. The first sound data AS1 included in the second moving image file 28B is sound data having the first bit depth obtained by digitizing the sound signal AS output from the external microphone 13. The first sound data AS1 may be any one of the first modulated sound data ASM1 or the second modulated sound data ASM2. The first moving image file 28A is an example of “first file” according to the technique of the present disclosure. The second moving image file 28B is an example of “second file” according to the technique of the present disclosure.

Further, in the present embodiment, the main controller 60 generates a first icon indicating the first moving image file 28A and a second icon indicating the second moving image file 28B, and outputs the first icon and the second icon to the display 15 in different display aspects. The display 15 displays the first icon and the second icon. The user can click any one of the first icon or the second icon using the operation unit 16 to selectively reproduce the first moving image file 28A and the second moving image file 28B.

The main controller 60 may cause the file creation unit 66 to create only one of the first moving image file 28A or the second moving image file 28B, in response to the operation of the operation unit 16 by the user.

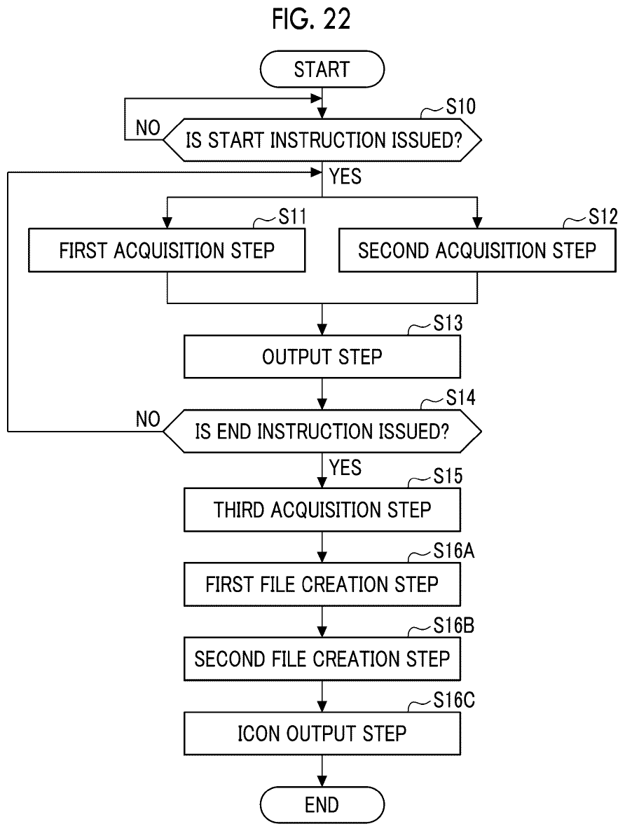

FIG. 22 is a flowchart showing an operation of the imaging apparatus according to the fourth embodiment. In the present embodiment, after the third acquisition step (step S15), a first file creation step (step S16A), a second file creation step (step S16B), and an icon output step (step S16C) are executed by the file creation unit 66.

In the first file creation step, the file creation unit 66 creates the first moving image file 28A. In the second file creation step, the file creation unit 66 creates the second moving image file 28B. In the icon output step, the main controller 60 outputs the first icon and the second icon to the display 15.

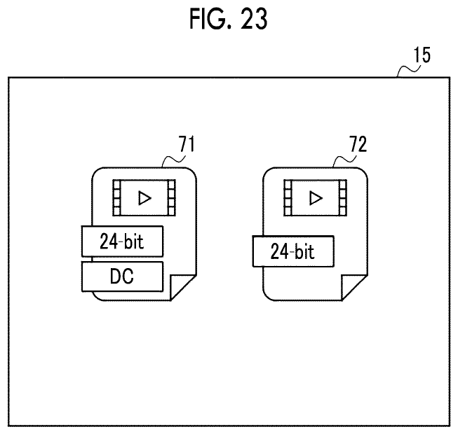

FIG. 23 shows an example of the first icon and the second icon displayed on the display 15. As shown in FIG. 23, the bit depth of the sound data included in the moving image file is displayed on a first icon 71 and a second icon 72.

The third sound data AS3 included in the first moving image file 28A and the first sound data AS1 included in the second moving image file 28B are both the sound data of 24 bits. In order to distinguish between the two sound data, the first icon 71 is attached with a character “DC” indicating that the third sound data AS3 included in the first moving image file 28A is generated by the down-conversion of the second sound data AS2F having a large bit depth. In the present embodiment, the display aspects of the first icon 71 and the second icon 72 are made different by attaching the character, but the display aspects may be made different by color, shape, or the like.

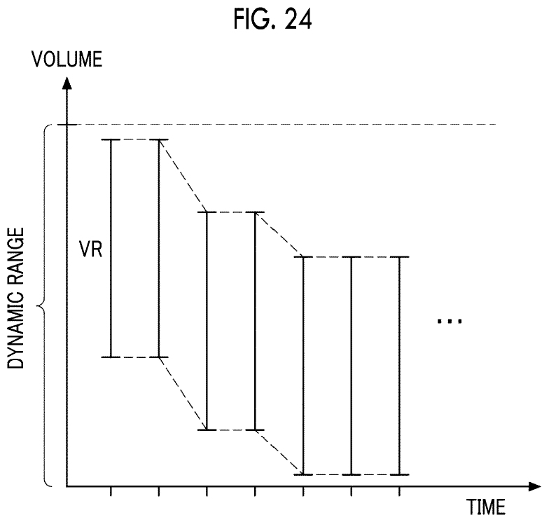

Further, the user can change the volume range VR of the second sound data AS2F for each predetermined time on a time axis by operating the operation unit 16, as shown in FIG. 24. Further, the user can also make the volume range VR constant without changing the volume range VR. Thus, the display aspect of the first icon 71 may be changed, based on whether or not the volume range VR of the third sound data AS3 included in the first moving image file 28A is changed on the time axis.

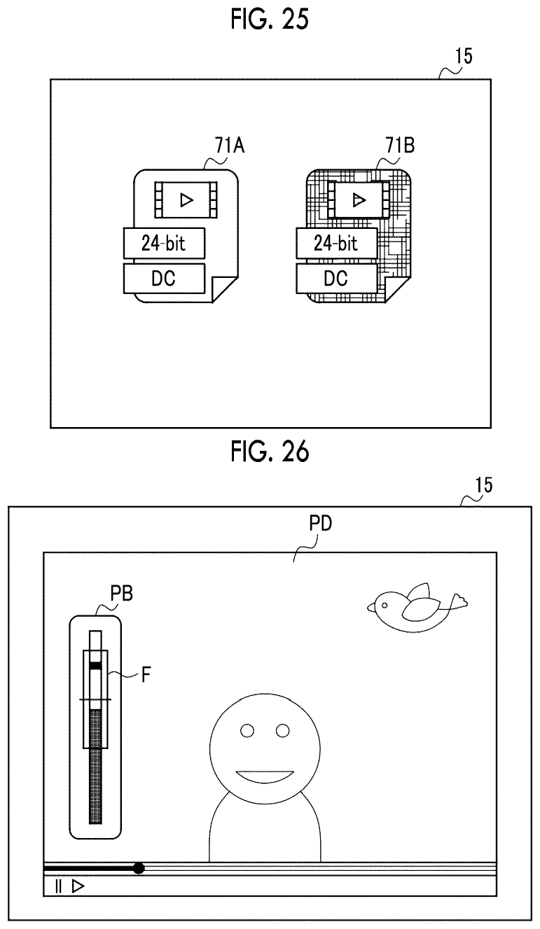

FIG. 25 shows a first icon 71A in a case where the volume range VR is changed and a first icon 71B in a case where the volume range VR is not changed. In the example shown in FIG. 25, a pattern is applied to the first icon 71B in order to change the display aspects of the first icon 71A and the first icon 71B. The display aspects may be different depending on a character, a color, a shape, and the like.

FIG. 26 shows an example of a video reproduction screen. In a case where the first moving image file 28A is reproduced, the main controller 60 causes the display 15 to display a volume video PB similar to the volume video PA, which is shown in FIG. 13 described in the modification example of the first embodiment. Further, in a case where the first moving image file 28A including the third sound data AS3 whose volume range VR is changed on the time axis is reproduced, the main controller 60 changes a position of a frame F indicating the volume range VR set in a case where the third sound data AS3 is created, according to a reproduction time. In the present embodiment, the volume range VR is indicated by the frame F, but may be indicated by another display aspect such as a bar.

The same modification as the first embodiment can also be employed for the present embodiment.

The technique of the present disclosure is not limited to the digital camera and can also be employed for electronic devices such as a smartphone and a tablet terminal having an imaging function.

In the above embodiment, various processors to be described below can be used as the hardware structure of the control unit with the processor 25 as an example. The above various processors include not only a CPU which is a general-purpose processor that functions by executing software (programs) but also a processor that has a changeable circuit configuration after manufacturing, such as an FPGA. The FPGA includes a dedicated electrical circuit that is a processor which has a dedicated circuit configuration designed to execute specific processing, such as PLD or ASIC, and the like.

The control unit may be configured by one of these various processors or a combination of two or more of the processors of the same type or different types (for example, a combination of a plurality of FPGAs or a combination of a CPU and an FPGA). Alternatively, a plurality of control units may be configured with one processor.

A plurality of examples in which a plurality of control units are configured as one processor can be considered. As a first example, there is an aspect in which one or more CPUs and software are combined to configure one processor and the processor functions as a plurality of control units, as represented by a computer such as a client and a server. As a second example, there is an aspect in which a processor that implements the functions of the entire system, which includes a plurality of control units, with one IC chip is used, as represented by system on chip (SOC). In this manner, the control unit can be configured by using one or more of the above various processors as the hardware structure.

Furthermore, more specifically, it is possible to use an electrical circuit in which circuit elements such as semiconductor elements are combined, as the hardware structure of these various processors.

The above embodiment and respective modification examples can be combined as appropriate as long as there is no contradiction.

The above contents and illustrated contents are detailed descriptions of parts related to the technique of the present disclosure, and are merely examples of the technique of the present disclosure. For example, the descriptions regarding the configurations, the functions, the actions, and the effects are descriptions regarding an example of the configurations, the functions, the actions, and the effects of the part according to the technique of the present disclosure. Accordingly, in the contents described and the contents shown hereinabove, it is needless to say that removal of an unnecessary part, or addition or replacement of a new element may be employed within a range not departing from the gist of the present technique of the present disclosure. In order to avoid complication and easily understand the parts according to the technique of the present disclosure, in the above contents and illustrated contents, common technical knowledge and the like that do not need to be described to implement the technique of the present disclosure are not described.

All documents, patent applications, and technical standards described in the present specification are incorporated in the present specification by reference to the same extent as in a case where each document, patent application, and technical standard are specifically and individually noted to be incorporated by reference.

The following technique can be understood by the above description.

### Supplementary Note 1

A display method comprising:
a first acquisition step of acquiring, based on first sound data having a first bit depth generated based on a sound signal output from a first sound collection device, second sound data having a second bit depth larger than the first bit depth; and
an output step of outputting, to a display device, a volume video representing a volume related to the second sound data.

### Supplementary Note 2

The display method according to Supplementary Note 1, further comprising:
a second acquisition step of acquiring a subject video representing a video of a subject,
wherein, in the output step, the volume video and the subject video are output to the display device.

### Supplementary Note 3

The display method according to Supplementary Note 1 or 2,
wherein the volume video includes any one of a first video representing a level of the volume or a second video representing a change in the volume smaller than the level represented by the first video.

### Supplementary Note 4

The display method according to Supplementary Note 3,
wherein the volume video includes the second video, and
the second video is a video representing a temporal change amount of the volume or a video obtained by enlarging a part of the first video.

### Supplementary Note 5

The display method according to Supplementary Note 3,
wherein the volume video includes the first video and the second video,
the first sound data includes first modulated sound data obtained by employing a first gain for the sound signal and second modulated sound data obtained by employing a second gain higher than the first gain for the sound signal,
the second sound data is sound data generated by combining the first modulated sound data and the second modulated sound data, and
the first video represents a level of a volume of the first modulated sound data, and the second video represents a level of a volume of the second modulated sound data.

### Supplementary Note 6

The display method according to Supplementary Note 3,
wherein the volume video includes the first video,
the first sound data includes first modulated sound data obtained by employing a first gain for the sound signal and second modulated sound data obtained by employing a second gain higher than the first gain for the sound signal,
the second sound data is sound data generated by combining the first modulated sound data and the second modulated sound data, and
the first video is a video in which a volume of the second sound data is represented by the second bit depth.

### Supplementary Note 7

The display method according to Supplementary Note 3 or 6, further comprising:
a third acquisition step of acquiring, based on the second sound data, third sound data generated by extracting data of a volume range having a width of a third bit depth smaller than the second bit depth,
wherein the volume video includes a third video related to the third sound data.

### Supplementary Note 8

The display method according to Supplementary Note 7,
wherein the volume video includes the first video and the third video, and
the third video is a video related to a volume of the third sound data.

### Supplementary Note 9

The display method according to any one of Supplementary Notes 1 to 8, further comprising:
a fourth acquisition step of acquiring a volume of an environmental sound based on a sound signal output from a second sound collection device,
wherein the volume video includes information related to the volume of the environmental sound.

### Supplementary Note 10

The display method according to Supplementary Note 9,
wherein the volume video includes information related to a ratio between the volume related to the second sound data and the volume of the environmental sound.

### Supplementary Note 11

A display method comprising:
a first acquisition step of acquiring, based on first sound data having a first bit depth generated based on a sound signal output from a first sound collection device, second sound data having a second bit depth larger than the first bit depth;
a third acquisition step of acquiring, based on the second sound data, third sound data generated by extracting data of a volume range having a width of a third bit depth smaller than the second bit depth; and
an output step of outputting, to a display device, an auxiliary video related to the third sound data.

### Supplementary Note 12

The display method according to Supplementary Note 11, further comprising:
a second acquisition step of acquiring a subject video representing a video of a subject, wherein, in the output step, the subject video is output to the display device in addition to the auxiliary video.

### Supplementary Note 13

The display method according to Supplementary Note 11 or 12,
wherein the auxiliary video is a video related to the volume range.

### Supplementary Note 14

The display method according to Supplementary Note 12,
wherein the auxiliary video is a video related to deterioration information, which is information on a sound deteriorated from the second sound data in the third sound data.

### Supplementary Note 15

The display method according to Supplementary Note 14,
wherein the deterioration information is information related to a sound source of the deteriorated sound.

### Supplementary Note 16

The display method according to Supplementary Note 15, further comprising:
an extraction step of extracting, from the subject video, subject information corresponding to the sound source,
wherein the deterioration information is the subject information.

### Supplementary Note 17

A display method comprising:
a first file creation step of creating, based on first sound data having a first bit depth generated based on a sound signal output from a first sound collection device, second sound data having a second bit depth larger than the first bit depth and creating a first file including third sound data generated, based on the second sound data, by extracting data of a volume range having a width of a third bit depth smaller than the second bit depth;
a second file creation step of creating a second file including the first sound data; and
an output step of outputting, to a display device, a first icon indicating the first file and a second icon indicating the second file in different display aspects.

### Supplementary Note 18

The display method according to Supplementary Note 17,
wherein, in the first file creation step, the volume range of the second sound data is changeable for each predetermined time, and
in the output step, the display aspect of the first icon is changed based on whether or not the volume range is changed on a time axis.

What is claimed is:

1. A display method comprising:
a first acquisition step of acquiring, based on first sound data having a first bit depth generated based on a sound signal output from a first sound collection device, second sound data having a second bit depth larger than the first bit depth; and
an output step of outputting, to a display device, a volume video representing a volume related to the second sound data.

2. The display method according to claim 1, further comprising:
a second acquisition step of acquiring a subject video representing a video of a subject,
wherein, in the output step, the volume video and the subject video are output to the display device.

3. The display method according to claim 1,
wherein the volume video includes any one of a first video representing a level of the volume or a second video representing a change in the volume smaller than the level represented by the first video.

4. The display method according to claim 3,
wherein the volume video includes the second video, and
the second video is a video representing a temporal change amount of the volume or a video obtained by enlarging a part of the first video.

5. The display method according to claim 3,
wherein the volume video includes the first video and the second video,
the first sound data includes first modulated sound data obtained by employing a first gain for the sound signal and second modulated sound data obtained by employing a second gain higher than the first gain for the sound signal,
the second sound data is sound data generated by combining the first modulated sound data and the second modulated sound data, and
the first video represents a level of a volume of the first modulated sound data, and the second video represents a level of a volume of the second modulated sound data.

6. The display method according to claim 3,
wherein the volume video includes the first video,
the first sound data includes first modulated sound data obtained by employing a first gain for the sound signal and second modulated sound data obtained by employing a second gain higher than the first gain for the sound signal,
the second sound data is sound data generated by combining the first modulated sound data and the second modulated sound data, and
the first video is a video in which a volume of the second sound data is represented by the second bit depth.

7. The display method according to claim 3, further comprising:
a third acquisition step of acquiring, based on the second sound data, third sound data generated by extracting data of a volume range having a width of a third bit depth smaller than the second bit depth,
wherein the volume video includes a third video related to the third sound data.

8. The display method according to claim 7,
wherein the volume video includes the first video and the third video, and
the third video is a video related to a volume of the third sound data.

9. The display method according to claim 1, further comprising:
a fourth acquisition step of acquiring a volume of an environmental sound based on a sound signal output from a second sound collection device,
wherein the volume video includes information related to the volume of the environmental sound.

10. The display method according to claim 9,
wherein the volume video includes information related to a ratio between the volume related to the second sound data and the volume of the environmental sound.

11. A display method comprising:
a first acquisition step of acquiring, based on first sound data having a first bit depth generated based on a sound signal output from a first sound collection device, second sound data having a second bit depth larger than the first bit depth;
a third acquisition step of acquiring, based on the second sound data, third sound data generated by extracting data of a volume range having a width of a third bit depth smaller than the second bit depth; and
an output step of outputting, to a display device, an auxiliary video related to the third sound data.

12. The display method according to claim 11, further comprising:
a second acquisition step of acquiring a subject video representing a video of a subject,
wherein, in the output step, the subject video is output to the display device in addition to the auxiliary video.

13. The display method according to claim 11,
wherein the auxiliary video is a video related to the volume range.

14. The display method according to claim 12,
wherein the auxiliary video is a video related to deterioration information, which is information on a sound deteriorated from the second sound data in the third sound data.

15. The display method according to claim 14,
wherein the deterioration information is information related to a sound source of the deteriorated sound.

16. The display method according to claim 15, further comprising:
an extraction step of extracting, from the subject video, subject information corresponding to the sound source,
wherein the deterioration information is the subject information.

17. A display method comprising:
a first file creation step of creating, based on first sound data having a first bit depth generated based on a sound signal output from a first sound collection device, second sound data having a second bit depth larger than the first bit depth and creating a first file including third sound data generated, based on the second sound data, by extracting data of a volume range having a width of a third bit depth smaller than the second bit depth;
a second file creation step of creating a second file including the first sound data; and
an output step of outputting, to a display device, a first icon indicating the first file and a second icon indicating the second file in different display aspects.

18. The display method according to claim 17,
wherein, in the first file creation step, the volume range of the second sound data is changeable for each predetermined time, and
in the output step, the display aspect of the first icon is changed based on whether or not the volume range is changed on a time axis.

19. An information processing apparatus comprising:
a processor,
wherein the processor is configured to execute
a first acquisition step of acquiring, based on first sound data having a first bit depth generated based on a sound signal output from a first sound collection device, second sound data having a second bit depth larger than the first bit depth, and
an output step of outputting, to a display device, a volume video representing a volume related to the second sound data.

20. An information processing apparatus comprising:
a processor,
wherein the processor is configured to execute
a first acquisition step of acquiring, based on first sound data having a first bit depth generated based on a sound signal output from a first sound collection device, second sound data having a second bit depth larger than the first bit depth,
a third acquisition step of acquiring, based on the second sound data, third sound data generated by extracting data of a volume range having a width of a third bit depth smaller than the second bit depth, and
an output step of outputting, to a display device, an auxiliary video related to the third sound data.

21. An information processing apparatus comprising:
a processor,
wherein the processor is configured to execute
a first file creation step of creating, based on first sound data having a first bit depth generated based on a sound signal output from a first sound collection device, second sound data having a second bit depth larger than the first bit depth and creating a first file including third sound data generated, based on the second sound data, by extracting data of a volume range having a width of a third bit depth smaller than the second bit depth,
a second file creation step of creating a second file including the first sound data, and
an output step of outputting, to a display device, a first icon indicating the first file and a second icon indicating the second file in different display aspects.
